(19) United States
(12) Patent Application Publication
(10) Pub. No.: US 2005/0140802 A1
(43) Pub. Date: Jun. 30, 2005

(54) Method for synthesizing photographed image with background scene in appratus having a camera

(75) Inventor: Soo-Young Nam, Dong-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/017,863

(22) Filed: Dec. 22, 2004

(30) Foreign Application Priority Data
Dec. 27, 2003 (KR) 2003-98167

(51) Int. Cl. H04N 5/262

(52) U.S. Cl. 348/239

(57) ABSTRACT

An apparatus and method for photographing an image in an apparatus including an image memory and a camera, the image memory storing each series of background scenes including two or more background scenes are provided. The apparatus and method comprising selecting the series of background scenes in a mode of setting the series of background scenes and displaying single background scene of the selected series of background scenes in a set time interval; synthesizing the series of background scenes with an image photographed by the camera and displaying the synthesized image in a preview mode; and storing the displayed synthesized image in the image memory when a record command occurs in the preview mode.

### PRIORITY

This application claims the benefit under 35 U.S.C. 119(a) of an application entitled “Method for Synthesizing Photographed Image with Background Scene in Apparatus Having Camera” filed in the Korean Intellectual Property Office on Dec. 27, 2003 and assigned Serial No. 2003-98167, the entire contents of which are incorporated herein by reference.

### BACKGROUND OF THE INVENTION

1. Field of the Invention

The present invention relates to an apparatus and method for photographing a moving picture in an apparatus equipped with a camera. More particularly, the present invention relates to an apparatus and method capable of capable of synthesizing a photographed image with a background scene selected by a user.

2. Description of the Related Art

Generally, an image processing apparatus includes a camera for photographing an image and a display module for displaying an image signal photographed by the camera. Herein, the camera may use a charge-coupled device (‘CCD’) or a complementary metal-oxide semiconductor (‘CMOS’) sensor and the display module may use a liquid crystal display (‘LCD’). With the miniaturization of the camera device, a device for photographing the image is reduced. Further, miniaturized digital cameras have become popular. Additionally, the aforementioned camera device has been mounted on a portable terminal. The portable terminal can photograph an image, convert the photographed image to a moving picture or a still picture, and display the moving picture or the still picture. Further, the portable terminal can transmit the photographed image to a base station.

When an apparatus equipped with the camera photographs a moving picture, the apparatus may store audio signals with photographed moving picture signals. Further, editing functions capable of editing the photographed moving picture signals by adding other functions to currently photographed moving picture signals have been realized. The editing functions as described above include a method of synthesizing the photographed image with other images.

### SUMMARY OF THE INVENTION

Accordingly, the present invention has been made to solve the above-mentioned problems occurring in the prior art, and it is an object of the present invention to provide an apparatus and method by which a user of an apparatus having a camera can synthesize an image photographed using the camera with one of background scenes selected by the user and can edit the synthesized image.

It is another object of the present invention to provide an apparatus and method by which a user of an apparatus having a camera can select a series of background scenes while images are photographed and synthesize the selected series of background scenes with the photographed image.

It is further another object of the present invention to provide an apparatus and method capable of setting a display time of a series of background scenes and images of the series of background scenes when the series of background scenes is synthesized with moving picture signals in an apparatus equipped with a camera.

It is yet another object of the present invention to provide an apparatus and method by which a user can construct selected background scenes as a series of background scenes in an apparatus which includes a camera and synthesizes photographed moving picture signals with a series of background scenes.

It is yet another object of the present invention to provide an apparatus and method by which a user can synthesize photographed moving picture signals with a selected series of background scenes and store the synthesized image in a portable phone having a camera.

In accordance with one aspect of the present invention, there is provided an apparatus and method for photographing an image in an apparatus having an image memory and a camera, the image memory storing each series of background scenes including two or more background scenes. The apparatus and method comprising selecting the series of background scenes in a mode for setting the series of background scenes and displaying a single background scene of the selected series of background scenes in a set time interval; synthesizing the series of background scenes with an image photographed by the camera and displaying the synthesized image in a preview mode; and storing the displayed synthesized image in the image memory when a record command occurs in the preview mode.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a mobile terminal according to an embodiment of the present invention;

FIG. 2 is a block diagram illustrating of an image processor of FIG. 1;

FIG. 3 is a flow diagram illustrating a procedure of synthesizing an image with a background scene in a portable terminal according to one embodiment of the present invention;

FIG. 4 is a flow diagram illustrating a procedure of setting the series of background scenes and the renewal time in FIG. 3;

FIG. 5 is a flow diagram illustrating a procedure of setting the series of background scenes in FIG. 4;

FIG. 6 is a flow diagram illustrating a procedure of generating the series of background scenes in FIG. 4;

FIG. 7 is a flow diagram illustrating a procedure of synthesizing the background scene with the image photographed by a camera in FIG. 3;

FIG. 8 is a flow diagram illustrating a procedure of synthesizing an image with a background scene in a portable terminal according to another embodiment of the present invention; and

FIG. 9 is a flow diagram illustrating a procedure of setting the series of background scenes in FIG. 8.

### DETAILED DESCRIPTION OF THE PREFERRED EMBODIMENT

Hereinafter, an embodiment of the present invention will be described with reference to the accompanying drawings. It should be noted that the same reference numerals are used to designate the same elements as those shown in other drawings.

In the embodiment of the present invention, an image photographed by an apparatus equipped with a camera or a photographed and stored image file is synthesized with a series of background scenes including two or more background scenes, so that a synthesis image file is generated. An apparatus capable of generating the synthesis image file includes an apparatus equipped with a camera. Such apparatuses may include portable terminals equipped with digital cameras and non-digital cameras. In an embodiment of the present invention, a description will be given based on a portable terminal equipped with a camera.

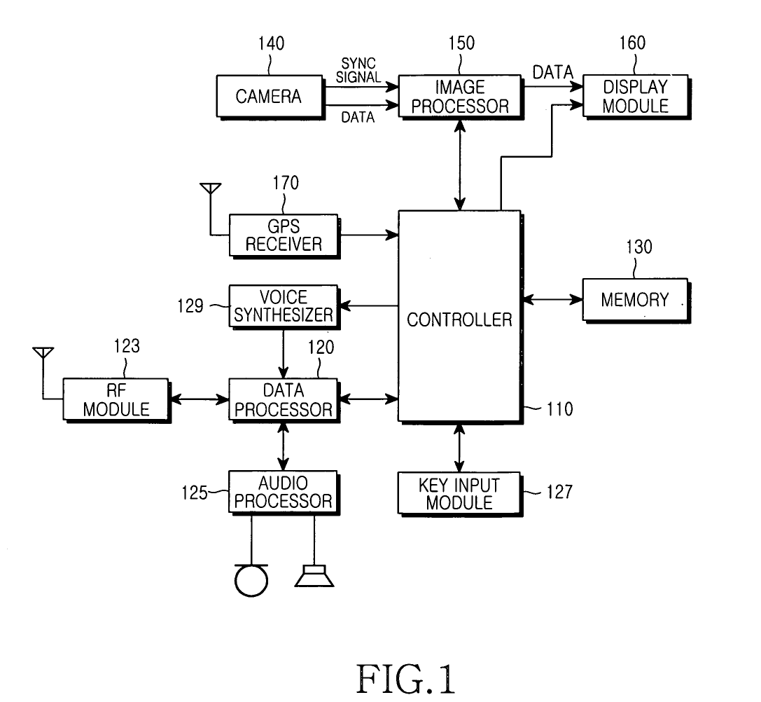

FIG. 1 is a block diagram illustrating a portable terminal according to an embodiment wherein the portable terminal may comprise a portable phone.

Referring to FIG. 1, a radio frequency (RF) module 123 performs a wireless communication function of a portable phone. The RF module 123 includes an RF transmitter (not shown) for up-converting and amplifying the frequency of a transmitted signal, an RF receiver (not shown) for low-noise amplifying a received signal and down-converting the frequency of the received signal, etc. A data processor 120 includes a transmitter for coding and modulating the transmitted signal, a receiver for demodulating and decoding the received signal, etc. The data processor 120 may comprise a modem and a codec. Herein, the codec includes a data codec processing packet data, etc and an audio codec processing an audio signal such as voice. An audio processor 125 performs a function of reproducing a received audio signal output from the audio codec of the data processor 120 or transmitting a transmission audio signal generated from a microphone to the audio codec of the data processor 120. A voice synthesizer 129 performs a function of converting a voice message into a voice signal for indicating that photographing is being performed if an incoming call occurs during photographing a moving picture.

A key input module 127 includes keys for inputting numerals and text information and function keys for setting various functions. Further, the key input module 127 may include function keys for performing a mode for photographing a synthesis moving picture and a photographing key for controlling a camera according to an embodiment of the present invention.

A memory 130 may include a program memory, a data memory, and a moving picture memory for storing image signals generated and received according to an embodiment of the present invention. The program memory may store programs for an image photographing, a call processing, etc., of a portable phone program for synthesizing photographed image signals with a series of background scenes according to an embodiment of the present invention. Further, the data memory performs a function of temporarily storing data generated while the programs are executed.

A controller 110 performs a function of controlling the general operation of a portable phone. Further, the controller 110 may include the data processor 120. That is, in the case of a portable phone, the controller 110, the data processor 120, the audio processor 125 and the voice synthesizer 129 may be integrated to one MSM chip. The controller 110 may synthesizes the photographed image signals with the series of background scenes set or generated by a user and store the synthesized image according to an embodiment of the present invention.

A camera module 140 includes a camera sensor for converting an optical signal an image into an electrical signal and a signal processing unit for converting an analog image signal photographed by the camera sensor into digital data. Herein, it is assumed that the camera sensor is a CCD sensor and the signal processing unit may comprise a digital signal processor (DSP). Further, the camera sensor may be integrated with the signal processing unit or the camera sensor may be separate from the signal processing unit.

An image processor 150 performs a function of generating screen data for displaying the image signal output from the camera module 140. The image processor 150 processes the image signal output from the camera module 140 by the frame and outputs image data in accordance with the characteristic and the size of the display module 160. Further, the image processor 150 includes an image codec 250 and the image codec 250 performs a function of coding an image signal by a set scheme or decoding coded frame image data into the original frame image data. Herein, the image codec 250 may include a joint photographic expert group (JPEG) codec and/or a moving picture expert group (MPEG) codec.

The display module 160 displays the image signal output from the image processor 150 on a screen and displays user data output from the controller 110. Herein, the display module 160 may use a liquid crystal display (LCD). In such a case, the display module 160 may include an LCD controller, a memory capable of storing image data, an LCD display device, etc. Herein, when the LCD has a touch screen function, the display module 160 may operate as an input module.

A global positioning system (‘GPS’) receiver 170 receives GPS information from a GPS satellite to transmit the received GPS information to the controller 110. Herein, the GPS information may become information on the current position of a portable phone. In the embodiment of the present invention, position information and time information relating to the acquisition of a current moving picture can be received through the GPS receiver 170.

Referring to FIG. 1, when a user performs a dialing operation through the key input module 127 in originating a call, the controller 110 detects the dialing operation, processes dial information received through the data processor 120, converts the processed dial information to an RF signal through the RF module 123, and outputs the RF signal. Then, when the called party respond, the controller 110 detects the response of the called party through the RF module 123 and the data processor 120. Then, the controller 110 forms a communication path including the RF module 123, the data processor 120 and the audio processor 125 and performs a communication function.

Further, in an incoming call, the controller 110 detects an incoming request through the data processor 120 and alerts the called party to the incoming call via an audible, visual or vibratory alert. Herein, when the portable phone is in an image-photographing mode, the controller 110 displays the information of a calling party on the display module 160 and simultaneously alerts the called party of the incoming call. Further, when the incoming call occurs while photographing is being performed, the controller 110 performs a silent termination alert. The reason for performing the silent termination alert in this manner is because the incoming ringing sound is inadvertently recorded when the incoming ringing occurs in a photographing state and the swing of an image signal being photographed may occur when a vibration mode is performed. Further, when a guidance function in photographing is set, the controller 110 can output a voice signal reporting that the user cannot answer the telephone to the caller through the voice synthesizer 129.

Further, when the user presses a communication key in response to the incoming call, the controller 110 stops photographing an image and processes the incoming call. Then, when the processing of the incoming call ends, the controller 110 shifts to a preview state and displays an image on the screen that was previously photographed. Further, the controller 110 stores image information photographed together with a file name input by the user.

As described above, the portable phone according to an embodiment of the present invention can photograph a person or the surrounding environment and display or transmit an image of the photographed person or the surrounding environment. Meanwhile, the camera module 140 may be equipped with a portable phone or may connect to the predetermined position of an exterior of the portable phone. That is, the camera module 140 may an external-type camera or internal-type camera. The camera module 140 may include a sensor for photographing an image, a signal processor for converting an image signal photographed by the sensor into digital data, etc. The sensor may use a CMOS sensor or a CCD sensor. An image photographed by the camera module 140 is converted into an electrical signal by the internal sensor and the image signal is converted into the digital image data by the signal processor. The converted digital image signal and synchronization signals are output to the image processor 150. Herein, the synchronization signals may include horizontal synchronization signals, vertical synchronization signals, etc.

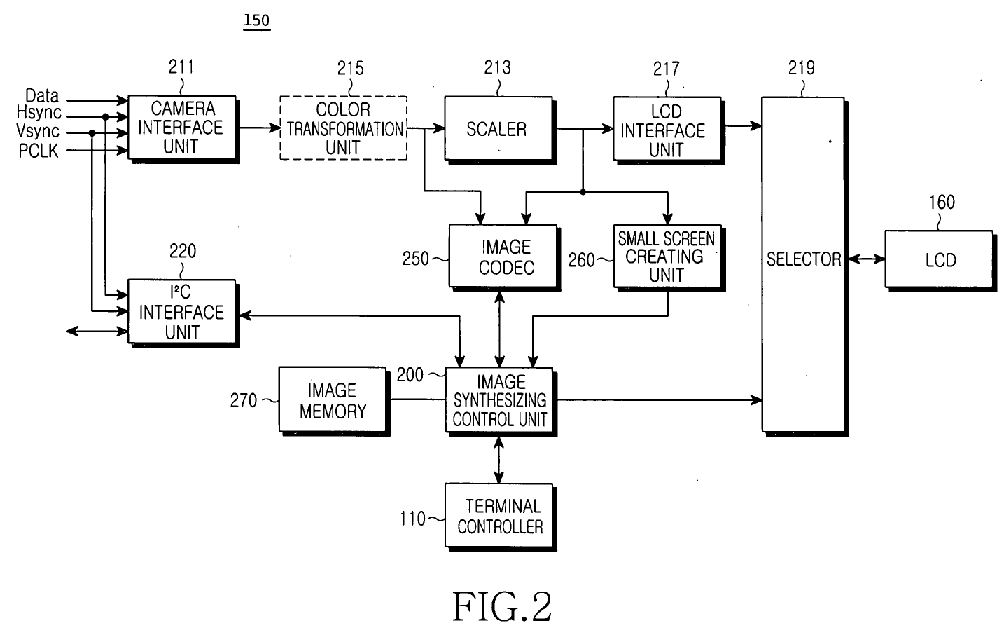

FIG. 2 is a block diagram illustrating the image processor 150 according to the embodiment of the present invention. The image processor 150 interfaces image signals between the camera module 140 and the display module 160 and performs a function of coding and decoding the image signals input from the camera module 140. Further, the image processor 150 performs a function of decimating and cropping the pixels and the lines of the image data of a coded main screen and generating a small screen. As described above, the image processor 150 includes the image codec 250 for coding and decoding image signals. In the embodiment of the present invention, a description will be given on an assumption that the image codec 250 is an MPEG codec.

Referring to FIG. 2, a camera interface unit 211 performs a function of interfacing image data output from the camera module 140. In the embodiment of the present invention, it is assumed that the image data output from the camera module 140 are image data of a YUV format and the display module 160 displays image data of an RGB format.

A scaler 213 scales image signals photographed by the camera module 140 according to a control signal output from the controller 110 so that the image signals can be displayed on the display module 160. The scaler 213 reduces and crops the pixels of the image signals output from the camera module 140 to be the number of pixels of image signals capable of being displayed on the display module 160. However, when the display module 160 can display image data having a size larger than that of the image data output from the camera module 140, the scaler 213 can be designed to enlarge and display the image signals output from the camera module 140 under the control of an image processing controller or image synthesizing control unit 200. According to a method for enlarging and displaying the image signals, pixels are selected from among the pixels of the image signals output from the camera module 140 by the number of pixels of image signals capable of being displayed on the display module 160, and the selected pixels displayed on the display module 160.

A color converter or color transformation unit 215 converts YUV data output from the scaler 213 to RGB data and outputs the RGB data. Herein, when the camera module 140 can convert photographed image data to RGB data or the display module 160 can display image data of a YUV format, the color converter 215 may be omitted.

A LCD interface unit 217 performs a function of interfacing the image data to the display module 160. The LCD interface unit 217 includes a buffer therein and can perform a function of buffering the image data interfaced to the display module 160.

The image codec 250 can perform a function of coding the photographed image data or restoring the coded image data under the control of an image processing controller 200. In the embodiment of the present invention, it is assumed that the image codec 250 is the MPEG codec. The image codec 250 inputs and performs an MPEG coding for the camera image signals output from the color converter 215 or the image signals displayed on the display module 160 under the control of the image processing controller 200. Further, the first image codec 250 decodes the MPEG-coded image signals and outputs the decoded image signals to the scaler 213 or the LCD interface unit 217. That is, the image codec 250 can code and decode the camera images or the displayed images.

The image processing controller 200 controls the generation operation of the image processor 150. That is, the image processing controller 200 controls the display module 160 under the control of the controller 110 and controls the generation operation for displaying the image data photographed by the camera module 140. Herein, the image processing controller 200 can directly process the key data input from the key input module 127 in the image processing. In the embodiment of the present invention, the controller 110 confirms the key input generated from the key input module 127. When the key input is key data relating to the image processing, the controller 110 transmits the key input to the image processing controller 200 and the image processing controller 200 performs commands regarding the image processing.

An image memory 270 stores image information photographed under the control of the image processing controller 200 and stores photographed or received image data. The image memory 270 may be contained in the memory 130. Further, the image memory 270 stores background scenes to be synthesized with the moving picture photographed according to the embodiment of the present invention. Herein, the background scenes may also be stored as series of background scenes and individual background scenes.

A selector 219 performs a function of outputting user data and communication data under the control of the controller 110 in a standby mode and communication mode and outputting the image data photographed under the control of the image processing controller 200 in an image photographing mode.

Referring to FIG. 2, in an image photographing mode, the controller 110 transfers a control right of an image processing to the image processing controller 200. Then, the image processing controller 200 enables user data sent from the controller 110 to be displayed on the display module 160. Besides, the image processing controller 200 controls an operation enabling image data photographed by the camera module 140 to be displayed on the display module 160 and an operation enabling image signals photographed by the command of a user to be stored in the memory 130. That is, the controller 110 controls an operation relating to communication and controls the operation of the display module 160 only when a communication function is performed. Further, when the operation of the camera module 140 is selected, the image processing controller 200 controls the general operation of the portable terminal.

Hereinafter, an operation in which the image data photographed by the camera module 140 are transmitted to the display module 160 will be described. The image processor 150 stores the image data photographed by the camera module 140 in the memory of the display module 160 through the LCD interface unit 217. Herein, the size of image data of one frame output from the camera module 140 may be different from the number of pixels of one frame image data capable of being displayed on the display module 160. Accordingly, the scaler 213 of the image processor 150 can erase some of the pixels of the image data output from the camera module 140 so that the image data can be displayed on the display module 160, or can select a predetermined area including some of the pixels and zoom the selected area.

Further, in the course of displaying the image signals photographed by the camera module 140 on a moving picture screen of the display module 160, a user can store the displayed image signals. That is, the user can store the displayed image signals by means of the photographing key of the key input module 127. Herein, when a photographing command occurs, the image processing controller 200 controls the image codec 250 to code the image signals photographed by the camera module 140 and enables the coded data to be stored in the image memory 270.

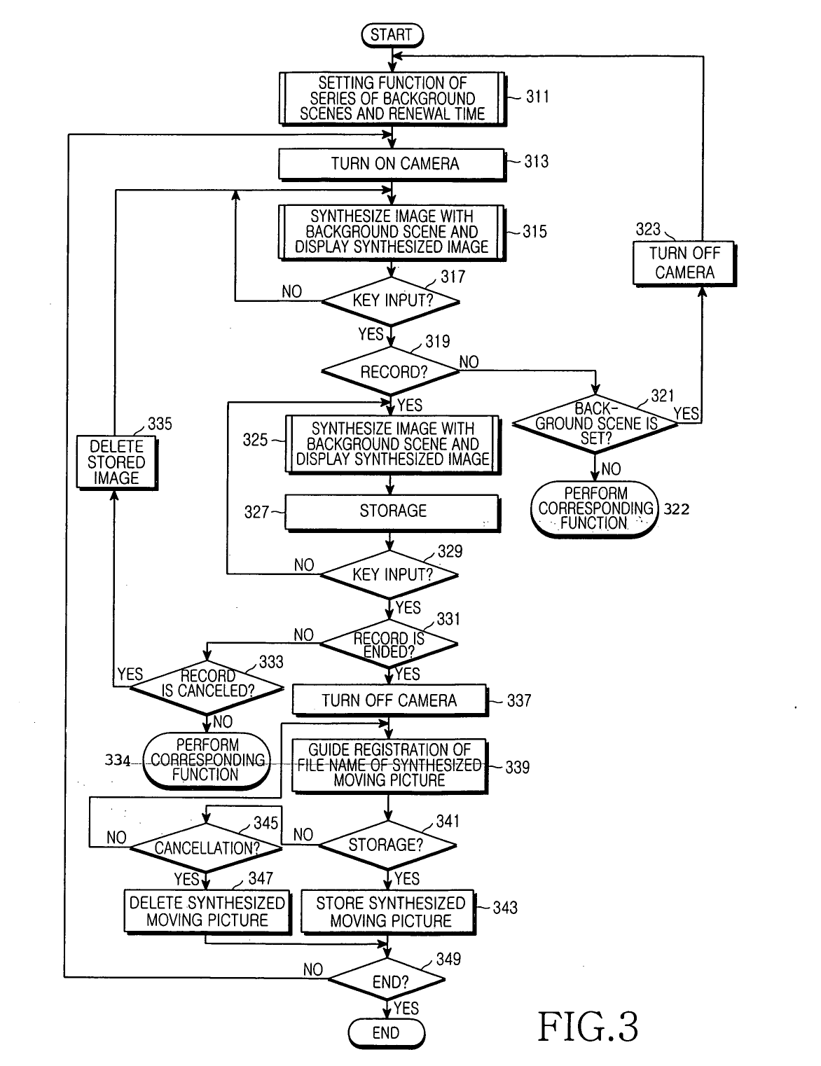

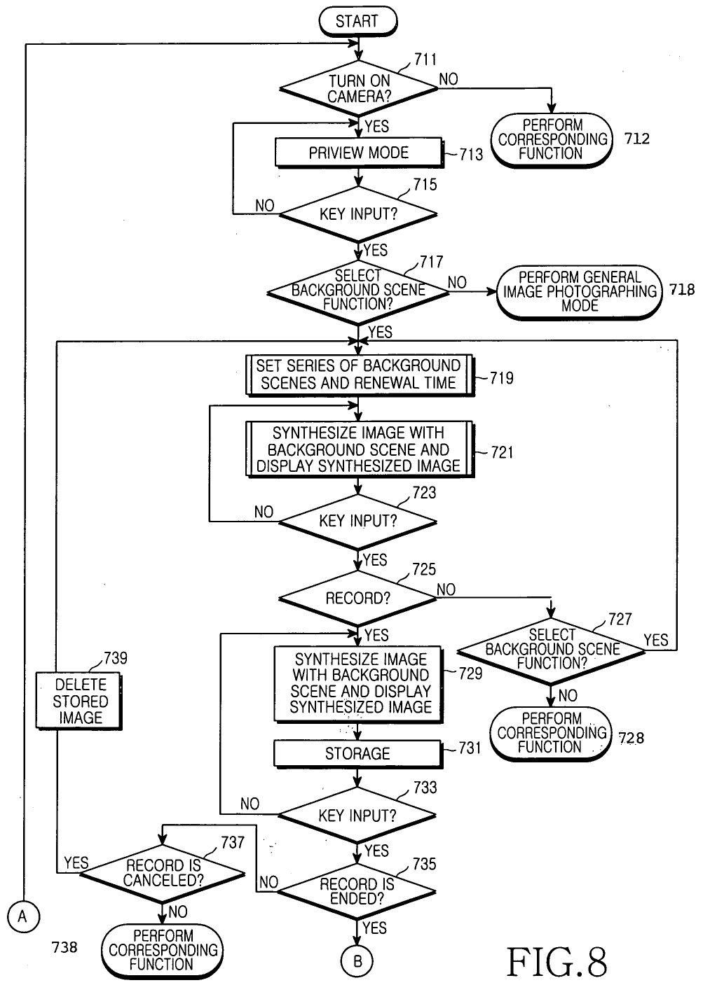

In the embodiment of the present invention, the photographed moving picture can be synchronized with the background scene by the following two methods. In the first method, the series of background scenes to be synchronized with the moving picture is first selected. Then, an image-photographing mode is performed and the selected series of background scenes is synchronized with the moving picture. In the second method, an image photographing mode is performed while a preview mode is first performed, a desired series of background scenes is selected in the preview mode, the image to be synchronized is confirmed, and the selected series of background scenes and the confirmed image are registered as synthesis moving picture signals. FIG. 3 is a flow diagram illustrating a procedure of the first method according to the embodiment of the present invention, and FIG. 8 is a flow diagram illustrating a procedure of the second method according to the embodiment of the present invention. Herein, the series of background scenes is a term signifying a background scene synchronized with photographed moving picture signals. Further, the series of background scenes may include two or more background scenes and the number of the background scene may be variably set.

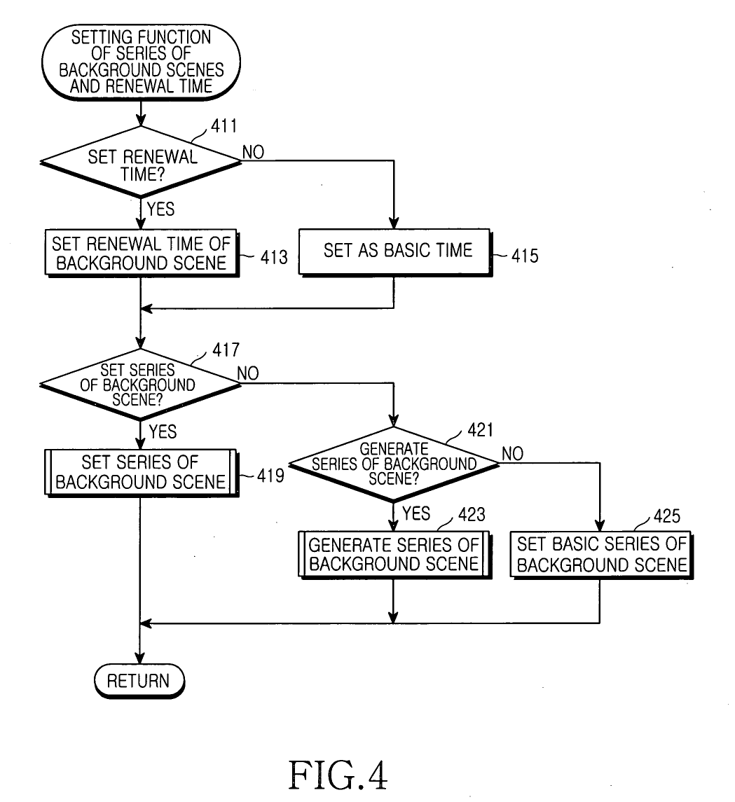

FIG. 3 is a flow diagram illustrating a procedure by which the background scenes are synchronized with the moving picture photographed in an image-photographing mode according to the embodiment of the present invention. FIG. 4 is a flow diagram illustrating a procedure of setting the series of background scenes and the renewal time in FIG. 3;

Referring to FIG. 3, first, a user must set the series of background scenes to be synchronized with the moving picture signals and a time for synthesizing the background scene in step 311. When the series of background scenes and time setting are selected, the image processing controller 200 performs a procedure for setting a time in step 411 at which the series of background scenes and the background scene are synchronized with the moving picture signals according to the procedure as shown in FIG. 3, in step 311. In the series of background scenes and the time setting of the step 311, a renewal time setting operation of the background scene and selection or generation operation of the series of background scenes are performed.

Referring to FIG. 4, the image processing controller 200 inspects whether time information for setting the renewal time of the background scene is input or not. As a result of the inspection, when the time information is input, the image processing controller 200 registers a time input in step 413 as the renewal time of the background scene. In contrast, when the time information is not input, the image processing controller 200 sets a previously used time or a preset time as the renewal time of the background scene in step 415. In the embodiment of the present invention, it is assumed that the background scene is set to be renewed according to a time. However, the background scene may be set to be renewed based on the number of frames of the moving picture signals. That is, the moving picture signals contain a predetermined number of photographed frame images each second. Accordingly, the renewal time of the background scene may be set according to the number of photographed frames.

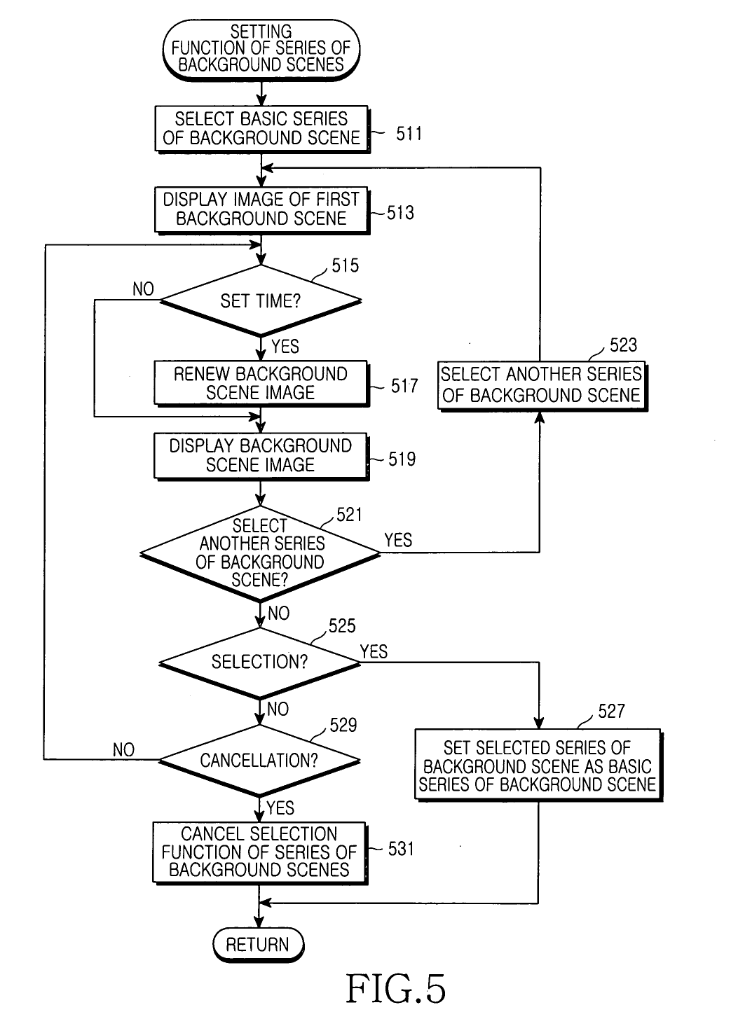

After setting the renewal time of the background scene as described above, a user may select or generate the series of background scenes. When the user selects the series of background scenes, the image processing controller 200 detects the selection of the series of background scenes in step 417 and selects the series of background scenes in step 419. The selection of the series of background scenes as described above indicates that a desired series of background scenes is selected from series of background scenes generated in advance. The selection of the series of background scenes is performed by the procedure as shown in FIG. 5.

Referring to FIG. 5, when the series of background scenes is selected, the image processing controller 200 selects a basic series of background scenes from the image memory 270 in step 511. The basic series of background scenes may include a series of background scenes used in a previous state or a preset series of background scenes. After selecting the basic series of background scenes in step 511, the image processing controller 200 accesses a first background scene in the selected basic series of background scenes in step 513. Then, the image processing controller 200 inspects whether a current time is the set time or not in step 515. As a result of the inspection, when the current time is not the set time, the image processing controller 200 maintains the selected background scene. In contrast, when the current time is the set time, the image processing controller 200 selects the next background scene from the series of background scenes in step 517. Then, the image processing controller 200 displays the selected background scene on the display module 160 in step 519. Then, the image processing controller 200 determines whether another series of background scenes is selected or not in step 521. As a result of the inspection, when another series of background scenes is selected, the image processing controller 200 detects the selection of another series of background scenes. Then, the image processing controller 200 accesses the series of background scenes selected from the image memory 270 in step 523 and returns to step 513 to repeat the aforementioned operations. As described above, the image processing controller 200 displays the background scenes of the selected series of background scenes on the display module 160 in predetermined time intervals. Further, the user can select a desired series of background scenes in the course of displaying the background scenes and images of the selected series of background scenes are sequentially displayed in the set reference time intervals.

In the course of displaying the background scenes of the series of background scenes as described above, when the user generates a selection command, the image processing controller 200 detects the selection command in step 525. Further, the image processing controller 200 sets and stores the series of background scenes being currently displayed as a basic series of background scenes in step 527. In contrast, in the course of displaying the series of background scenes, when the user generates a cancel command, the image processing controller 200 detects the cancel command in step 529. Further, the image processing controller 200 cancels and ends a selection function of the series of background scenes in step 531. In such a case, the image processing controller 200 may store a photographed moving picture without synthesis of the series of background scenes.

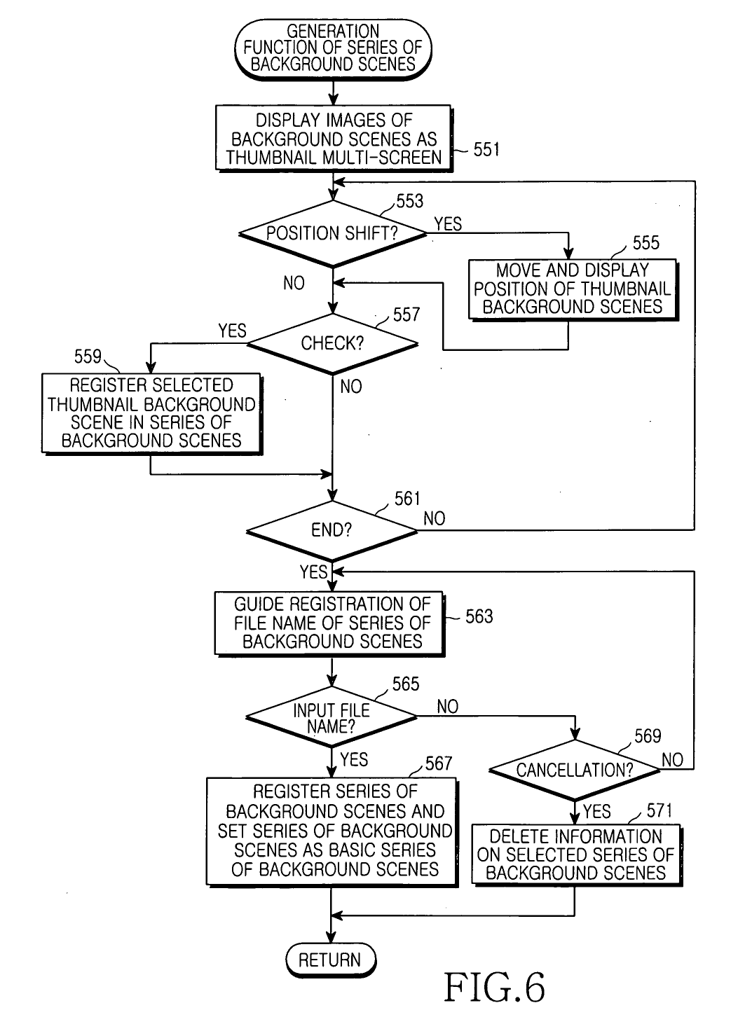

Referring to FIG. 4, after setting the renewal time of the background scene as described above, a user may generate the series of background scenes. When the user selects the series of background scenes, the image processing controller 200 detects the selection of the series of background scenes in step 421 and generates the series of background scenes in step 423. The generation procedure of the series of background scenes as described above indicates that the user selects desired background scenes from the background scenes and generates a new series of background scenes. If the user does not select the series of background scenes, the image processing controller 200 sets the basic series of the background scene in step 425. The selection of the series of background scenes is performed by the procedure as shown in FIG. 6.

Referring to FIG. 6, when the generation of the series of background scenes is selected, the image processing controller 200 displays the background scenes stored in the image memory 270 as thumbnail images in step 551. That is, when the series of background scenes is selected, the image processing controller 200 accesses the thumbnail images in a thumbnail image area of the image memory 270 and displays the thumbnail images on the display module 160. Accordingly, the display module 160 displays a plurality of thumbnail background scenes. In a state in which the thumbnail background scenes are displayed, the user can move a cursor to a desired position of a background scene by using a position shift key. The position shift key may include a navigation key. Accordingly, when the user operates a left/right direction key of the navigation key, the cursor moves leftward/rightward. That is, the cursor can move a horizontal position of the thumbnail background scenes. Further, when the user operates an up/down direction key of the navigation key, the cursor moves upward/downward. That is, the cursor can move a vertical position of the thumbnail background scenes. Herein, more than four or six thumbnail background scenes can be displayed on the display module 160 displaying multiple screens, and new thumbnail background scenes can be displayed on the display module 160 according to operation of the position shift key. When the position shift key is input as described above, the image processing controller 200 detects the input of the position shift key in step 553. Further, the image processing controller 200 moves the position of the cursor in a horizontal direction or a vertical direction on the display module 160 and designates a thumbnail background scene selected by the user in step 555. Moreover, the image processing controller 200 can access and display thumbnail images of another background scene stored in the image memory 270 according to movement of the position shift key in step 555.

After selecting the desired background scene on the display module 160 while moving the position shift key, the user presses a confirmation key and can register the selected background scene as a series of background scenes. Accordingly, when the confirmation key is input, the image processing controller 200 detects the input of the confirmation key in step 557 and registers the currently designated background scene as the series of background scenes in step 559. As described above, the user can select desired background scenes from the background scenes by using the position shift key and the confirmation key, and register the selected background scenes as the series of background scenes.

Meanwhile, when an end key is pressed during the generation of the series of background scenes through the aforementioned procedure, the image processing controller 200 detects the occurrence of the end key in step 561 and outputs a guidance menu for registering the name of a currently generated series of background scenes in step 563. Further, when the file name of the series of background scenes is input, the image processing controller 200 detects the input of the file name in step 565, stores the file name and the data of the series of background scenes and ends the procedure in step 567. In contrast, when a cancel key is input in step 569, the image processing controller 200 deletes the data of the generated series of background scenes in step 571.

As described above, in step 311 of setting the series of background scenes and the renewal time, the image processing controller 200 sets the series of background scenes to be synthesized with the moving picture signals and the renewal time of the background scene. Further, the series of background scenes may also be generated by selecting a desired series of background scenes or background scenes from series of background scenes generated in advance.

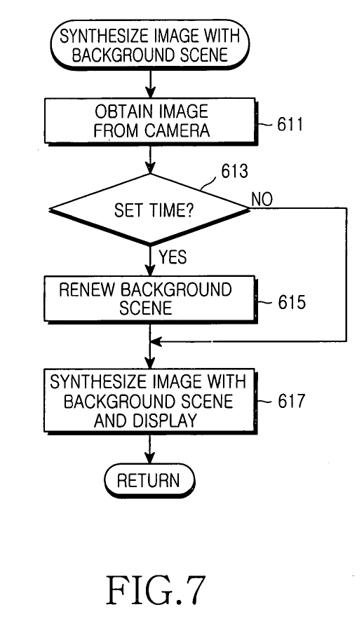

Referring now to FIG. 3, after setting the series of background scenes and the renewal time, when a photographing mode is performed, the image processing controller 200 turns on the camera module 140 in step 313. Then, images signals photographed by the camera module 140 are synthesized with the set background scene and displayed on the display module 160 in step 315. FIG. 7 is a flow diagram illustrating an operation for synthesizing the images signals photographed by the camera module 140 with the set background scene.

Referring to FIG. 7, the image processing controller 200 receives the images signals photographed by the camera module 140 in step 611, and synthesizes the received images signals with the background scene at a corresponding time point and displays the synthesized image on the display module 160, in step 617. Herein, when accessing the background scene, the image processing controller 200 inspects whether a current time is the renewal time of the series of background scenes in step 613. As a result of the inspection, when the current time is the renewal time, the image processing controller 200 accesses the next background scene in step 615 and synthesizes the accessed background scene with the image in step 617. In contrast, when the current time is not the renewal time, the image processing controller 200 maintains the current background scene. Then, the image processing controller 200 synthesizes the image with the background scene in step 617. Accordingly, when synthesizing the images photographed by the camera module 140 with the set series of background scenes in step 315, the image processing controller 200 synthesizes a photographed image with the background scene while maintaining the current background scene for a reference time. Further, the image processing controller 200 accesses the next background scene at the renewal time and then synthesizes an image photographed for the reference time with the background scene again. In the same manner as described above, the image processing controller 200 sequentially accesses the series of background scenes and the accessed background scenes are maintained for the reference time and then synthesized with photographed images. Further, when the final background scene of the series of background scenes is completely synthesized, the image processing controller 200 accesses a first background scene of another series of background scenes and repeats the aforementioned operations until the photographing is ended.

In a state in which the synthesized image obtained by synthesizing the image with the background scene is displayed on the display module 160 in step 315, the user of the portable terminal sees a screen of the synthesized image displayed on the display module 160 and determines whether to record the synthesized image. Herein, when the user presses a record key, the image processing controller 200 detects the input of the record key through steps 317 and 319 and stores the synthesized image of the image and the background scene in the image memory 270 through steps 325 and 327. The image data stored in the image memory 270 are image data obtained by synthesizing the data of the image with the data of the background scene. The synthesized image data generated in step 325 are generated through the same procedure as the synthesis procedure of the image data synthesized in step 315. Herein, when the synthesized image data are generated by a record command in step 325, the image processing controller 200 can initialize a variable of a series of background scenes, designate the first background scene of the series of background scenes, and synthesize the first background scene with a photographed image. Further, the image processing controller 200 may also store the synthesized image currently displayed in a preview mode in step 325.

Further, the image processing controller 200 can change a selection of a series of background scenes in a state where the synthesized image is displayed in a preview mode in step 315. When a change command of the series of background scenes occurs in the preview mode, the image processing controller 200 detects the occurrence of the change command in step 321, turns off the camera module 140 in step 323, returns to step 311 and performs the operation of step 311 again. If the background scene is not set in step 321, the controller 200 performs a corresponding function in step 322. When the camera module 140 is turned off, the operation in the preview mode stops. Further, in step 311, the display operation of the series of background scenes set by the user is performed as described above.

While steps 325 and 327 are performed, the image processing controller 200 synthesizes the image photographed by the camera module 140 with the series of background scenes and displays the synthesized image. The displayed synthesized image is stored in the image memory 270 as described above. When the user presses a photographing end key in the aforementioned state, the image processing controller 200 detects the input of the photographing end key through steps 329 and 331, turns off the camera module 140 in step 337, and ends the photographing operation. Further, when the user presses a record cancel key during the image photographing, the image processing controller 200 detects the input of the record cancel key in step 333 and deletes the synthesized image data stored in the image memory 270 in step 335. Then, step 313 is performed. However, if a record cancel key was not input, the controller 200 performs a corresponding function in step 334.

Meanwhile, the image processing controller 200 turns off the camera module 140 by the record end command and displays menu information for registering the file name of the synthesized image stored in the image memory 270, in step 339. Herein, when the portable phone does not include the GPS receiver 170, the image processing controller 200 may display a menu for guiding an input of a moving picture photographing place/time and the file name of the synthesized image stored in the image memory 270. In contrast, when the portable phone includes the GPS receiver 170, the image processing controller 200 may display a menu for guiding an input of the file name of the synthesized image stored in the image memory 270 while displaying information on a photographing place and time displayed on the GPS receiver 170. The menu information may be generated by the image processing controller 200 or the controller 110. The generated information is user data and displayed on the display module 160.

In a state in which the menu is displayed as described above, when the image file name is input through the key input module 127, the image processing controller 200 detects the input of the image file name in step 341 and inputs information on a name and a photographing place/time corresponding to the synthesized image file stored in the image memory 270 in step 343. Herein, the user may also input only the name of the synthesized image file without inputting the information on the photographing place and time. In such a case, when the user inputs the name and presses a storage key, the image processing controller 200 registers only the name through information input to a name menu by the storage key.

Meanwhile, in a state in which the input of the file name of the synthesized image is guided, when the user generates a record cancel command, the image processing controller 200 detects the generation of the record cancel command in step 345 and deletes the image file stored in the image memory 270 in step 347. Then, when the user presses the end key, the image processing controller 200 detects the input of the end key in step 349 and ends the synthesis image photographing operation.

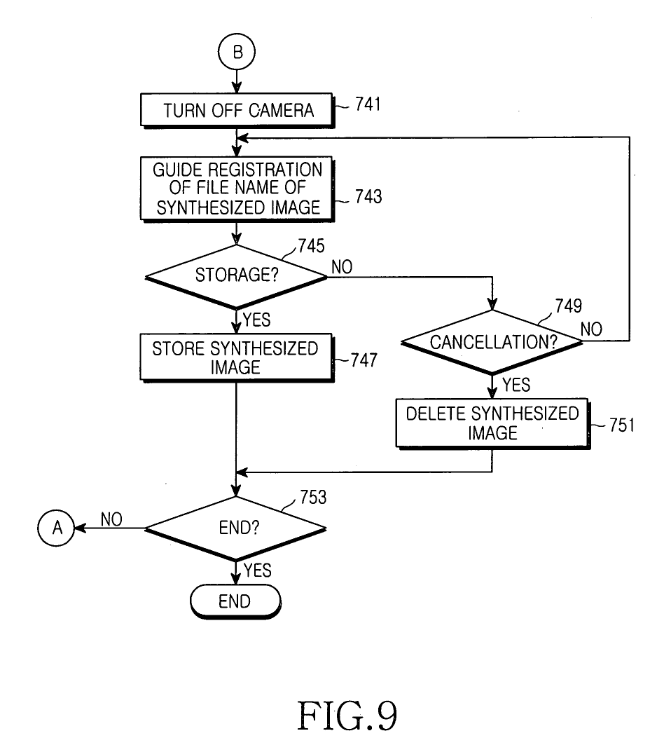

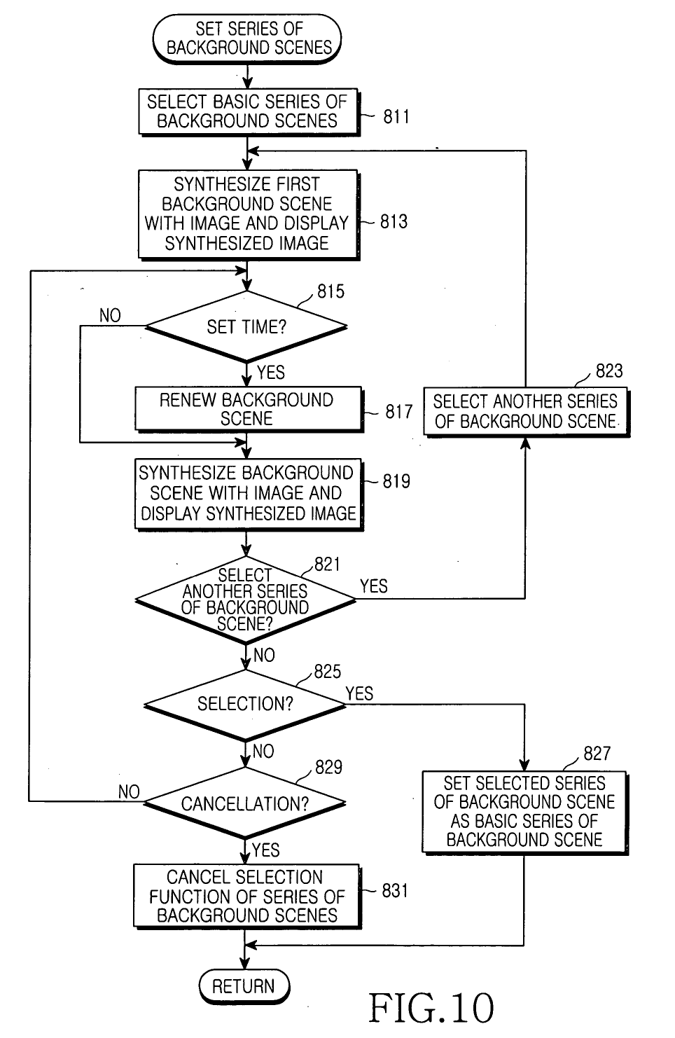

The synthesis image photographing method as shown in FIG. 3 includes a procedure of setting the series of background scenes, turning on the camera module 140, and synthesizing a photographed image with the set background scene. However, the camera module 140 is first turned on, a preview mode is performed, a desired series of background scenes is selected while the preview mode is performed, and then a synthesis image file may also be generated. FIGS. 8 and 9 are flow diagrams illustrating a procedure of performing the preview mode as described above and then setting the desired series of background scenes to generate the synthesis image file.

Referring to FIGS. 8 and 9, if the user does not turn on the camera, the controller 200 performs a corresponding function in step 712. If the user presses a camera key, the image processing controller 200 detects the input of the camera key in step 711 and performs a preview mode of processing image signals photographed by the camera module 140 and displaying the processed image signals on the display module 160 in step 713. Further, when a set function of a series of background scenes is not selected in step 717, the image processing controller 200 performs a general image photographing function in step 718.

Herein, when a command for selecting a series of background scenes is generated while the preview mode is performed, the image processing controller 200 detects the generation of the command through steps 715 and 717 and sets the series of background scenes in step 719. FIG. 10 is a flow diagram illustrating a procedure of selecting the series of background scenes while the preview mode is performed according to the embodiment of the present invention.

Referring to FIG. 10, when the set function of the series of background scenes is selected, the image processing controller 200 selects a basic series of background scenes from the image memory 270 in step 811. Herein, the basic series of background scenes may include a series of background scenes used in a previous state or a preset series of background scenes. After selecting the basic series of background scenes in step 811, the image processing controller 200 accesses the first background scene from the selected basic series of background scenes, synthesizes the first background scene with the image photographed by the camera module 140, and displays the synthesized image on the display module 160, in step 813. Then, the image processing controller 200 determines whether a current time is a set time for renewing a background scene in step 815. As a result of the determination, when the current time is not the set time, the image processing controller 200 maintains the selected background scene. In contrast, when the current time is the set time, the image processing controller 200 selects the next background scene from the series of background scenes in step 817. Then, the image processing controller 200 synthesizes the selected background scene with the photographed image and displays the synthesized image on the display module 160 in step 819.

Further, the image processing controller 200 determines whether another series of background scenes is selected or not in step 821. As a result of the determination, when another series of background scenes is selected, the image processing controller 200 detects the selection of another series of background scenes. The image processing controller 200 accesses the series of background scenes selected from the image memory 270 in step 823, returns to step 813 and repeats the aforementioned operations. As described above, the image processing controller 200 changes the background scenes of the selected series of background scenes according to the set renewal time interval, synthesizes the background scenes with the photographed image, and displays the synthesized image on the display module 160. The display as described above denotes a display of an image obtained by synthesizing an image photographed in the preview mode with a series of background scenes. That is, the preview mode of the synthesized image may be performed. Further, the user can select a desired series of background scenes in the course of displaying the background scene and the images of the selected series of background scenes are sequentially displayed in the set reference time interval.

In the course of synthesizing the background scene of the series of background scenes with the photographed image and displaying the synthesized image as described above, when the user generates a selection command, the image processing controller 200 detects the generation of the selection command in step 825, sets the series of background scenes being currently displayed as a basic series of background scenes in step 827, and stores the basic series of background scenes. However, when the user generates a cancel command in the course of displaying the series of background scenes, the image processing controller 200 detects the generation of the cancel command in step 829, cancels the selection function of the series of background scenes in step 831, and ends the procedure. In such a case, the image processing controller 200 can store the photographed image without synthesis of the series of background scenes.

Referring to FIG. 8, as described above, when the series of background scenes and the renewal time are set, the image processing controller 200 performs the preview mode of the synthesized image, in which the image processing controller 200 synthesizes the series of background scenes with the photographed image and displaying the synthesized image as described above. Accordingly, when the series of background scenes and the renewal time are set in step 719, the image processing controller 200 performs the preview mode of the synthesized image in step 721, in which the image processing controller 200 synthesizes the image displayed in the preview mode with the generated series of background scenes and displaying the synthesized image.

In the state as described above, the user can store the synthesized image and the series of background scenes. Accordingly, in the preview mode of the synthesized image for displaying the series of background scenes and the image, when the user inputs the record key, the image processing controller 200 detects the input of the record key through steps 723 and 725 and stores the synthesized image displayed through steps 729 and 731 in the image memory 270. Herein, the display operation of the synthesized image in step 729 is performed by the aforementioned procedure of FIG. 7. Further, when a command of the user is a command regarding the set function of the series of background scenes, the image processing controller 200 detects the command of the user in step 727, returns to step 719 and sets the series of background scenes and the renewal time again according to the procedure as shown in FIG. 10.

Operations of steps 728, 729, 731, 733, 735, 737, 738, 739, 741, 743, 745, 747, 749, 751, and 753 are performed in a manner identical to the operations of steps 321, 322, 325, 327, 329, 331, 333, 334, 335, 337, 339, 341, 343, 345, 347 and 349 of FIG. 3. Accordingly, when the photographed image is synthesized with the background scene as shown in FIGS. 8 and 9, the image is first displayed in the preview mode, a desired series of background scenes is selected in the preview mode of the image, and the selected series of background scenes is displayed in the preview mode of the synthesized image. Then, a series of background scenes required by the user is selected in the preview mode of the synthesized image and an image synthesized with the selected series of background scenes can be stored.

Further, FIGS. 3, 8 and 9 mainly show procedures of synthesizing a series of background scenes at a time point at which an image is photographed. However, the method synthesizing the series of background scenes with the image may also be applied to an image photographed in advance. That is, in a case of a synthesized image realized by the procedure as shown in FIG. 3, a series of background scenes is first set. Then, an image file stored in the image memory 270 is accessed, the accessed image file is synthesized with the set series of background scenes, and the synthesized image can be stored. Further, in a case of an image realized by the procedure as shown in FIG. 8, an image file stored in the image memory 270 is first accessed. Then, a desired series of background scenes is set, the accessed image file is synthesized with the set series of background scenes, and the synthesized image can be stored. In the synthesis method as described above, a newly synthesized image file can be generated while an original image file is maintained intact.

In the present invention as described above, a series of background scenes, which includes two or more background scenes, required by a user is set in an apparatus equipped with a camera, and the set series of background scenes is synthesized with a photographed image and the synthesized image is displayed. Therefore, the function of an image photographing can be improved. Further, in the present invention, a method for synthesizing the image and the background scene as described above can be applied while photographing an image. Furthermore, in the present invention, the background scene can be synthesized with an already stored image.

Although a certain embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

1. A method for photographing an image in an apparatus having an image memory and a camera, the image memory storing each series of background scenes including two or more background scenes, the method comprising the steps of:
selecting the series of background scenes in a mode of setting the series of background scenes and displaying single background scene of the selected series of background scenes in a set time interval;
synthesizing the series of background scenes with an image photographed by the camera and displaying the synthesized image in a preview mode; and
storing the displayed synthesized image in the image memory when a record command occurs in the preview mode.

2. The method as claimed in claim 1, wherein the step of setting the series of background scenes comprises the steps of:
setting a renewal time of each background scene comprising the series of background scenes; and
selecting the series of background scenes stored in the image memory and sequentially displaying background scenes of the selected series of background scenes according to the renewal time.

3. The method as claimed in claim 1, wherein the step of setting the series of background scenes comprises the steps of:
setting a renewal time of each background scene comprising the series of background scenes; and
displaying the background scenes stored in the image memory, setting background scenes selected from the displayed background scenes as a series of background scenes, and sequentially displaying background scenes of the set series of background scenes according to the renewal time.

4. A method for photographing an image in an apparatus having an image memory and a camera, the image memory storing each series of background scenes including two or more background scenes, the method comprising the steps of:
displaying an image photographed by the camera in a preview mode;
renewing background scenes of the series of background scenes selected in a mode of setting the series of background scenes according to a set time interval, synthesizing the renewed background scenes with the photographed image, and displaying the synthesized image; and
storing the displayed synthesized image in the image memory when a record command occurs while the synthesized image is displayed.

5. The method as claimed in claim 4, wherein the step of setting the series of background scenes comprises the steps of:
setting a renewal time of each background scene comprising the series of background scenes; and
selecting the series of background scenes stored in the image memory and sequentially displaying background scenes of the selected series of background scenes according to the renewal time.

6. The method as claimed in claim 4, wherein the step of setting the series of background scenes comprises the steps of:
setting a renewal time of each background scene comprising the series of background scenes; and
displaying the background scenes stored in the image memory, setting background scenes selected from the displayed background scenes as a series of background scenes, and sequentially displaying background scenes of the set series of background scenes according to the renewal time.

7. A method for photographing an image in an apparatus having an image memory and a camera, the image memory storing each series of background scenes including two or more background scenes, the method comprising the steps of:
displaying the series of background scenes selected in a mode of setting the series of background scenes according to a set time interval;
when an image file stored in the image memory is selected while the series of background scenes is displayed, renewing each background scene of the series of background scenes according to the set time interval, synthesizing the selected image file with the renewed background scene, and displaying the synthesized image; and
storing the displayed synthesized image in the image memory when a record command occurs while the synthesized image is displayed.

8. A method for photographing an image in an apparatus having an image memory and a camera, the image memory storing each series of background scenes including two or more background scenes, the method comprising the steps of:
selecting an image file stored in the image memory and displaying an image of the selected image file in a preview mode;
renewing background scenes of the series of background scenes selected in a mode of setting the series of background scenes according to a set time interval, synthesizing the renewed background scenes with the displayed image, and displaying the synthesized image; and
storing the displayed synthesized image in the image memory when a record command occurs while the synthesized image is displayed.

9. An apparatus having a camera for photographing an image, comprising:
an image memory adapted to store each series of background scenes including two or more background scenes;
a controller adapted to select the series of background scenes when the apparatus is in a mode for setting the series of background scenes and displaying single background scene of the selected series of background scenes in a set time interval, synthesize the series of background scenes with an image photographed by the camera and display the synthesized image in a preview mode, and store the displayed synthesized image in the image memory when a record command occurs in the preview mode.

10. The apparatus as claimed in claim 9, wherein the controller is further adapted to set a renewal time of each background scene comprising the series of background scenes, and select the series of background scenes stored in the image memory and sequentially display background scenes of the selected series of background scenes according to the renewal time.

11. The apparatus as claimed in claim 9, wherein the controller is further adapted to set a renewal time of each background scene comprising the series of background scenes, display the background scenes stored in the image memory, set background scenes selected from the displayed background scenes as a series of background scenes, and sequentially display background scenes of the set series of background scenes according to the renewal time.
